(19) United States
(12) Patent Application Publication
(10) Pub. No.: US 2022/0072353 A1
(43) Pub. Date: Mar. 10, 2022

(54) MULTI-SHOT FIRE METERING SYSTEM

(71) Applicant: Ametek Ameron, LLC, Baldwin Park, CA (US)

(72) Inventors: Edwin R. Kho, Norwalk, CA (US); Souvanh Bounpraseuth, Ontario, CA (US)

(21) Appl. No.: 17/470,950

(22) Filed: Sep. 9, 2021

Related U.S. Application Data
(60) Provisional application No. 63/076,549, filed on Sep. 10, 2020.

(51) Int. Cl. A62C 35/02; A62C 3/08; A62C 35/10

(52) U.S. Cl. CPC A62C 35/023; A62C 35/10; A62C 3/08

(57) ABSTRACT

Multi-shot fire metering assemblies and a method for releasing fire extinguishing fluid from a multi-shot fire metering assembly. A multi-shot fire metering assembly may include a first fluid container. The first fluid container may include a first payload area for storing a fire extinguishing fluid. The multi-shot fire metering assembly may include a second fluid container. The second fluid container may be positioned within the first payload area. The second fluid container may include a second payload area for storing the fire extinguishing fluid. The multi-shot fire metering assembly may include a first discharge outlet for directing the fire extinguishing fluid when released.

### CROSS-REFERENCE TO RELATED APPLICATIONS

This application claims priority to and the benefit of U.S. Provisional Patent Application No. 63/076,549, titled “MULTI-SHOT FIRE METERING SYSTEM,” filed on Sep. 10, 2020, and the entirety of which is hereby incorporated by reference herein.

### BACKGROUND

### 1. Field

This specification relates to fire metering assemblies, particularly, multi-shot fire metering assemblies and a method for releasing fire extinguishing fluid from the same.

### 2. Description of the Related Art

Conventional fire extinguishing systems in commercial jet aircrafts generally use one or more fire metering systems to suppress fire in the cargo bay. For example, there may be one fire metering system in a forward cargo bay and one fire metering system in a rear cargo bay. Pilots of the aircrafts may respond to an indicator of fire in a specific cargo bay from the cockpit and activate a discharge of the fire metering system or systems in that cargo bay. Separate multiple fire metering systems may take up space, add extra weight, and expense more fire extinguishing fluid than needed to extinguish or suppress the fire. Further, each separate fire metering system may not have a back-up in case of damage to the fire metering system.

Accordingly, there is a need for assemblies and methods to provide multiple shots or deliveries of fire as needed and as a back-up while saving space and weight.

### SUMMARY

Examples described herein relate to embodiments of multi-shot fire metering assemblies and a method for releasing fire extinguishing fluid from the same. The multi-shot fire metering assemblies may include a first fluid container. The first fluid container may include a first payload area for storing a fire extinguishing fluid. The multi-shot fire metering assemblies may include a second fluid container. The second fluid container may include a second payload area for storing the fire extinguishing fluid. The multi-shot fire metering assemblies may include at least one discharge outlet for directing the fire extinguishing fluid when released.

In one aspect, the invention is embodied in a multi-shot fire metering assembly. The multi-shot fire metering assembly includes a first fluid container. The first fluid container includes a first payload area for storing a fire extinguishing fluid. The multi-shot fire metering assembly includes a second fluid container. The second fluid container is positioned within the first payload area. The second fluid container includes a second payload area for storing the fire extinguishing fluid. The multi-shot fire metering assembly includes a first discharge outlet for directing the fire extinguishing fluid when released.

These and other embodiments may optionally include one or more of the following features. The multi-shot fire metering assembly may include a second discharge outlet. The second discharge outlet may be in fluid communication with the second fluid container. The second discharge outlet may be configured to direct the fire extinguishing fluid when released. The first discharge outlet may be in fluid communication with the first fluid container. The multi-shot fire metering assembly may further include a first container cartridge. The first container cartridge may be configured to be electrically activated to shatter a first sealing disc to release the fire extinguishing fluid in the first payload area through the first discharge outlet. The first container cartridge may be a pyrotechnic device. The multi-shot fire metering assembly may further include a second container cartridge. The second container cartridge may be configured to be electrically activated to shatter a second sealing disc to release the fire extinguishing fluid in the second payload area through the second discharge outlet. The second container cartridge may be a pyrotechnic device. The multi-shot fire metering assembly may further include a computing device configured to activate the first container cartridge and the second container cartridge.

The multi-shot fire metering assembly may further include one or more fasteners or mounts coupled to an outer surface of the first fluid container. The one or more fasteners or mounts may be configured to mount or couple the first fluid container onto a wall or a surface of an aircraft. The multi-shot fire metering assembly may further include a temperature compensated pressure switch. The temperature compensated pressure switch may be configured to compensate for pressure change due to temperature in at least one of the first fluid container or the second fluid container.

In another aspect, the invention is embodied in a multi-shot fire metering assembly. The multi-shot fire metering assembly includes a first fluid container. The first fluid container includes a first payload area for storing a fire extinguishing fluid. The multi-shot fire metering assembly includes a second fluid container. The second fluid container includes a second payload area for storing the fire extinguishing fluid. The multi-shot fire metering assembly includes a discharge tube. The discharge tube is positioned in between the first fluid container and the second fluid container. The discharge tube includes a first sealing disc and a second sealing disc. The multi-shot fire metering assembly includes a discharge outlet. The discharge outlet includes a third sealing disc. The discharge outlet is configured to direct the fire extinguishing fluid when released.

These and other embodiments may optionally include one or more of the following features. The second fluid container may be in fluid communication with the first fluid container via the discharge tube when the second sealing disc is pierced or punctured. The multi-shot fire metering assembly may further include a first container cartridge. The first container cartridge may be configured to be electrically activated to shatter the third sealing disc to release the fire extinguishing fluid in the first payload area through the discharge outlet. The first container cartridge may be a pyrotechnic device. The multi-shot fire metering assembly may further include a second container cartridge. The second container cartridge may be configured to be electrically activated to shatter the first sealing disc and the second sealing disc to release the fire extinguishing fluid in the second payload area through the discharger outlet via the first fluid container. The multi-shot fire metering assembly may further include a computing device configured to activate the first container cartridge and the second container cartridge. The multi-shot fire metering assembly may further include a third fluid container. The third fluid container may have a third payload area for storing the fire extinguishing fluid. The multi-shot fire metering assembly may further include a second discharge tube positioned in between the second fluid container and the first fluid container. The second discharge tube may have a fourth sealing disc and a fifth sealing disc. The multi-shot fire metering assembly may further include a metering orifice positioned in between the second fluid container and the third fluid container. The metering orifice may be configured to control release of the fire extinguishing fluid in the third payload area.

The multi-shot fire metering assembly may further include one or more fasteners or mounts coupled to an outer surface of the first fluid container and an outer surface of the second fluid container. The one or more fasteners or mounts may be configured to mount or couple the first fluid container and the second fluid container onto a wall or a surface of an aircraft.

In another aspect, the invention is embodied in a method for releasing fire extinguishing fluid from a multi-shot fire metering assembly. The method includes shattering a first sealing disc by a cartridge of a first fluid container. The method includes releasing the fire extinguishing fluid from a first payload area of the first fluid container. The method includes shattering at least a second sealing disc by a cartridge of a second fluid container. The method includes releasing the fire extinguishing fluid from a second payload area of the second fluid container.

These and other embodiments may optionally include one or more of the following features. The second fluid container may be positioned within the first payload area. Releasing the fire extinguishing fluid from the first payload area and the second payload area may be controlled independently of each other.

The fire extinguishing fluid from the second payload area may be released into the first payload area after the fire extinguishing fluid from the first payload area is released where at least the second sealing disc may include a third sealing disc. The method may further include shattering a fourth sealing disc and a fifth sealing disc by a cartridge of a third fluid container and releasing the fire extinguishing fluid from a third payload area of the third fluid container into the second payload area after the fire extinguishing fluid from the second payload area is released. The fire extinguishing fluid from the third payload area may be released through a metering orifice positioned in between the second fluid container and the third fluid container.

### BRIEF DESCRIPTION OF THE DRAWINGS

Other systems, methods, features, and advantages of the present invention will be apparent to one skilled in the art upon examination of the following figures and detailed description. Component parts shown in the drawings are not necessarily to scale, and may be exaggerated to better illustrate the important features of the present invention.

FIG. 1 shows an example multi-shot fire metering assembly with an internal and external container according to an aspect of the present disclosure.

FIG. 2 shows a back side of the multi-shot fire metering assembly of FIG. 1 according to an aspect of the present disclosure.

FIG. 3A shows another example of a multi-shot fire metering assembly with two shots coupled via a discharge tube according to an aspect of the present disclosure.

FIG. 3B shows the multi-shot fire metering assembly of FIG. 3A with three shots according to an aspect of the present disclosure.

FIG. 4 shows a sectional view of a discharge tube of the multi-shot fire metering assembly of FIG. 3B according to an aspect of the present disclosure.

FIG. 5 shows a flow diagram of an example process for releasing fire extinguishing fluid from a multi-shot fire metering assembly according to an aspect of the present disclosure.

### DETAILED DESCRIPTION

A system, apparatus, device and/or method for delivering multiple shots of fire extinguishing fluid through a nozzle or a discharge outlet to knock down or extinguish a fire in a very short period is disclosed herein. The fire extinguishing fluid may be a fluid or other agent, such as Halon 1301, HFC-125 or other compressible agent. The multi-shot fire metering system utilizes multiple metering bottles or containers that have one or more discharge outlets in fluid communication with a hermetically sealed rupturable disc. By having multiple fluid containers, the multi-shot fire metering system may provide multiple shots or deliveries of the fluid in case the fire is not extinguished or otherwise suppressed after the first shot or the initial delivery of the fluid. Additionally, by having multiple fluid containers, the multi-shot fire metering system has both a primary and a secondary fluid container where one or the other fluid container acts as a back-up to the other fluid container in case the other fluid container is damaged.

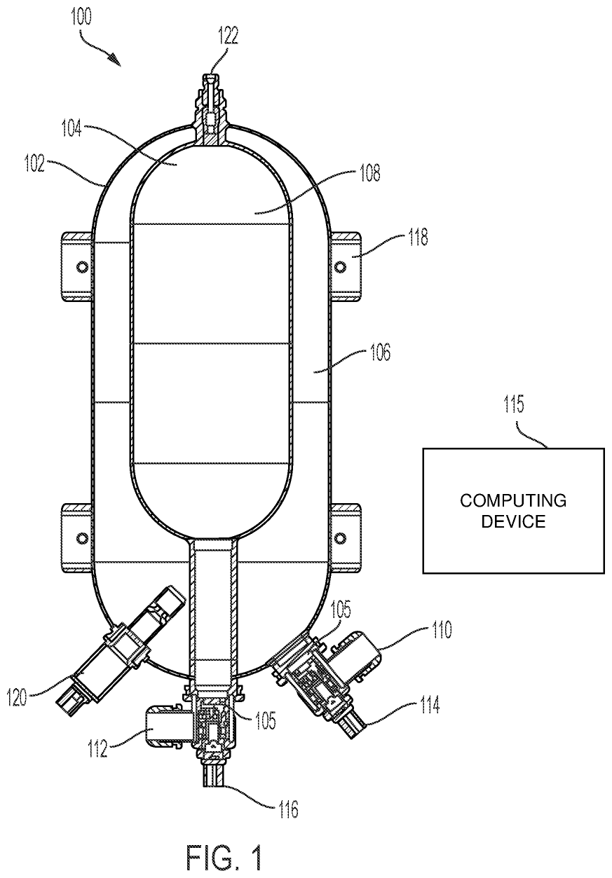

In one aspect, the multi-shot fire metering assembly (“fire metering assembly”) 100 uses an internal and external fluid container design, as shown in FIG. 1 for example. The fire metering assembly 100 may include one or more fluid containers, such as a first fluid container 102 and a second fluid container 104, one or more sealing discs 105, one or more discharge outlets 110,112, one or more container cartridges 114,116, and/or one or more passageways, which may be a Y-shaped tube, passage, or plumbing. Each fluid container 102,104 may act as a fail-safe for the other fluid container in case the other fluid container fails to activate. Moreover, the discharge outlets 110,112 may meter the delivery of the fluid to control the amount of fluid that is discharged.

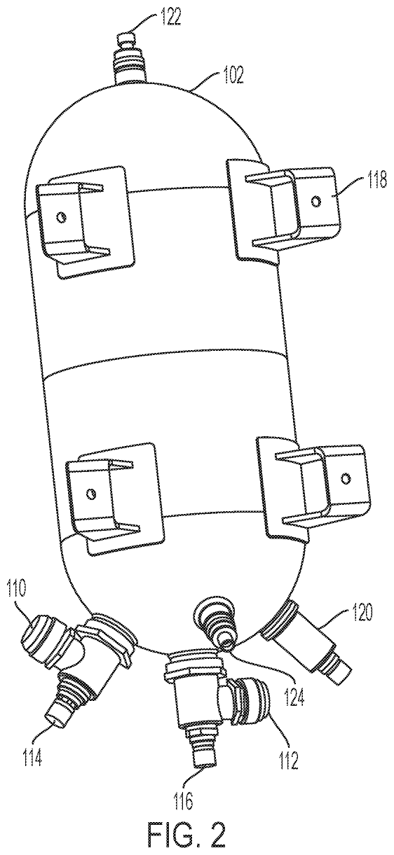

The fire metering assembly 100 may include any number of fluid containers made from a metallic or non-metallic material. Each fluid container may be made from welded pieces. The fluid containers 102,104 may have a spherocylinder shape as shown in FIG. 1. In some embodiments, the fluid containers may have another shape such as a cylinder or a sphere. The one or more fluid containers may be a fire metering bottle for mounting on an aircraft, such as within the forward or rear cargo bay of the aircraft. The one or more fluid containers 102,104 each may have a payload area 106,108, which may store a fire extinguishing fluid (“fluid”), such as Halon 1301, to extinguish, knock down, or otherwise suppress a fire within the cargo bay of the aircraft. The one or more fluid containers 102,104 may each have a fill fitting 122,124 to fill the one or more fluid containers 102,104 with the fluid. An internal container fill fitting 122 is shown in FIG. 1. An external container fill fitting 124 is shown in FIG. 2.

The second fluid container 104 may be positioned within the payload area 106 of the first fluid container 102. When the second fluid container 104 is positioned within the first fluid container 102, the second fluid container 104 may be referred to as an internal fluid container and the first fluid container 102 may be referred to as an external fluid container. The internal fluid container 104 and the external fluid container 102 may have separate payload areas 106,108 that may hold or contain the fluid. The external fluid container 102 may have a larger volume within the payload area 106 to contain more fluid than the payload area 108 of the internal fluid container 104. When the payload area 106 of the external fluid container 102 is filled with the fluid, the internal fluid container 104 may be surrounded by the fluid. And thus, if the internal fluid container 104 is compromised or otherwise damaged, any fluid within the payload area 108 of the internal fluid container 104 may leak into or equalize with the payload area 106 of the external fluid container 102 and may not be lost. This allows any leaked fluid from the payload area 108 of the internal fluid container 104 to be contained within the external fluid container 102 should the internal fluid container 104 be damaged or have any leaks. Similarly, if the fluid within the payload area 106 of the external fluid container 102 leaks, the internal fluid container 104 still contains fluid within the payload area 108, which may be discharged to suppress a fire or other hazard. Additionally, by positioning the internal fluid container 104 within the payload area of the external fluid container 102, the shell of the external fluid container 102 may protect the internal fluid container 104 from damage by external hazards and/or the surrounding environment. Finally, when the internal fluid container 104 is positioned within the payload area 106 of the external fluid container 102, the fire metering assembly 100 has a reduced size in comparison to placing two fluid containers adjacent to one another.

Each of the one or more fluid containers 102,104 may be fluidly coupled to a discharge outlet 110,112 via a passageway, such as a Y-shaped tube or passageway or discharge line. For example, the payload area 106 of the external fluid container may be in fluid communication via a passageway with the external discharge outlet 110 and the payload area 108 of the internal fluid container 104 may be fluid communication via another passageway or the same passageway with the internal discharge outlet 112. The Y-shaped tube or passageway or discharge line may fluidly couple the internal and external discharge outlets 110,112 with the payload areas 106,108 that contain the fluid. The Y-shaped tube or passageway provides for a more compact design, which minimizes the amount of plumbing between the payload areas 106,108 and the corresponding discharge outlets 110,112, which saves weight, cost, and space because the plumbing is more compact and less material is used to discharge the fluid in comparison to a design that uses two adjacent fluid containers.

In some embodiments, the fire metering assembly 100 may have a single discharge outlet. The one or more discharge outlets 110,112 may be a nozzle that directs the fluid when released out from the one or more fluid containers 102,104 to extinguish, suppress, or otherwise knock-out a fire or other hazard in the cargo bay when the one or more container cartridges 114,116 are activated or actuated.

The fire metering assembly 100 may have one or more container cartridges, such as an external container cartridge 114 and an internal container cartridge 116. The one or more container cartridges may be an actuation device, which may be mechanically or electrically activated, such as an explosive pyrotechnic device or cartridge. The actuation device may be electrically activated to detonate and shatter, destroy, or otherwise tear apart or puncture a sealing disc 105, such as a hermetically sealed rupturable disc, to allow the fluid, which may be pressurized, to flow from the payload area through the passageway and be released out through the one or more discharge outlets. For example, a computing device 115 may be programmed or instructed to activate the container cartridges 114,116. The computing device 115 may activate the container cartridges 114,116 independent from each other. The activation of the container cartridges 114,116 may be simultaneous or sequential. The fire metering assembly 100 may have a screen that captures fragments of the sealing disc 105 that is shattered when the container cartridge is energized.

The fire metering assembly 100 may have one or more fasteners or mounts 118. The one or more fasteners or mounts 118 may be positioned in the rear of the first fluid container 102 as shown in FIG. 2 so that the fire metering assembly 100 may be fastened or mounted to a wall or a surface of the cargo bay of the aircraft. The fire metering assembly 100 may have a temperature compensated pressure switch 120. The temperature compensated pressure switch 120 may be inserted or positioned within the payload area 106 of the first fluid container 102 on one end to measure the pressure within the payload area 106 and may indicate whether there is a pressure drop within the payload area 106, which may indicate that there is a leak or that the fluid has been discharged. In some embodiments, the temperature compensated pressure switch 120 may be additionally or alternatively be inserted or positioned within the payload area 108. For example, the temperature compensated pressure switch 120 may be positioned where the internal container fill fitting 122 is shown in FIG. 1.

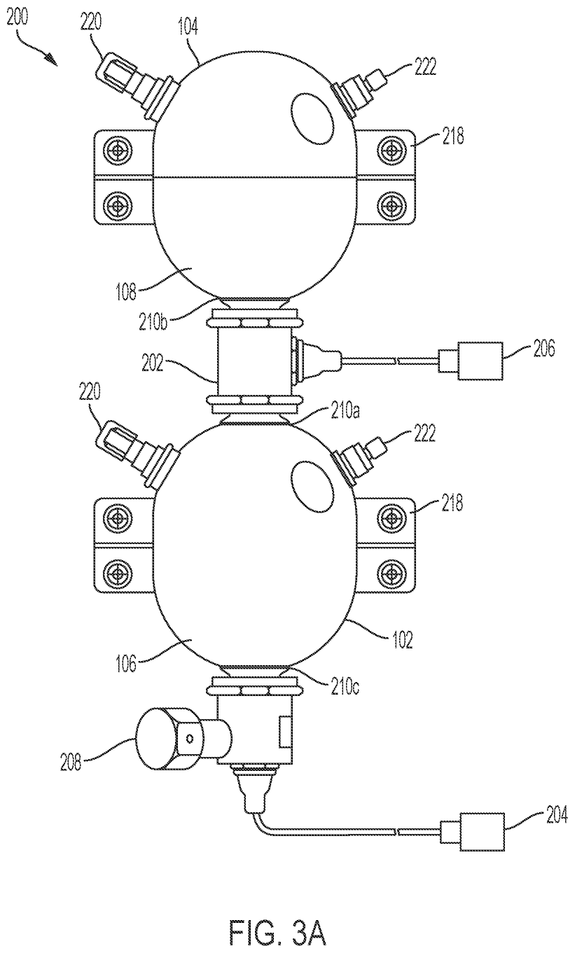

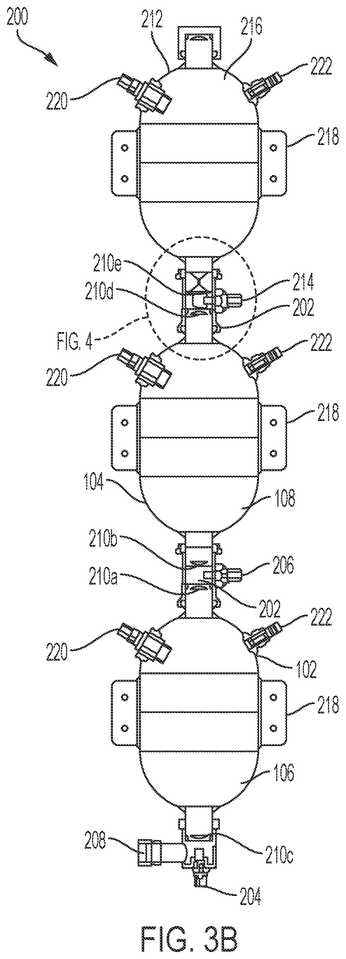

In another aspect, a fire metering assembly 200 may have multiple fluid containers coupled together and in fluid communication with each other when the one or more sealing discs 210a-c are punctured, pierced, or otherwise ruptured to allow fluid therethrough, while using a single discharge outlet 208, as shown in FIGS. 3A-3B for example. FIG. 3A shows the fire metering assembly 200 having two fluid containers, such as a primary fire bottle 102 and a second fire bottle 104, and FIG. 3B shows the fire metering assembly 200 having three fluid containers 102,104,212. The fire metering assembly 200 may have any number of fluid container positioned on top of one another with a discharge tube in between adjacent fluid containers that are on top of each other. The multiple fluid containers and the multiple discharge tubes may be interchangeable and modular allowing for the fluid containers to be positioned in various configurations. The multiple fluid containers may be metallic or non-metallic. Each fluid container may be made from welded pieces. The fluid containers 102,104,212 may have a spherocylinder shape as shown in FIG. 3B. In some embodiments, the fluid containers 102,104,212 may have another shape such as a cylinder or a sphere.

The fire metering assembly 200 may have one or more one or more discharge tubes 202 in between two or more fluid containers to interconnect the two or more fluid containers, such as the first fluid container 102 and the second fluid container 104. The discharge tube 202 may act as a conduit or passageway for fluid to flow from a back-up fluid container, such as the second fluid container 104, to flow into a preceding fluid container, such as the first fluid container 102 and out through the discharge outlet 208 when the appropriate or corresponding sealing discs are pierced, punctured, or otherwise ruptured. The discharge outlet 208 may direct the flow of the fluid when the sealing disc 210c is punctured, pierced, or otherwise ruptured to release the fluid.

On each end of the discharge tube 202 may be a sealing disc in between an opening of the discharge tube 202 and an opening of a fluid container. For example, there may be a first sealing disc 210a between the discharge tube 202 and the first fluid container 102 and a second sealing disc 210b between the discharge tube 202 and the second fluid container 104. Similarly, a third sealing disc 210c may be positioned between the first fluid container 102 and the discharge outlet 208. The fire metering assembly 200 has one or more container cartridges 204,206 similar to the container cartridges 114,116, as described above. When the primary container cartridge 204 is actuated or activated, the primary container cartridge 204 may rupture the third sealing disc 210c, which allows fluid from the payload area 106 of the first fluid container 102 to be released out the discharge outlet 208. When the secondary container cartridge 206 is actuated or activated, another of the one or more sealing discs 210a,210b that interface between the discharge tube 202 and the first fluid container 102 and the second fluid container 104 may be shattered, respectively. This allows fluid in the payload area 108 of the second fluid container 104 to flow through the discharge tube 202 into the payload area 106 of the first fluid container 102 and out and released through the discharge outlet 208. In some embodiments, a computing device 115 may be programmed or instructed to activate the container cartridges 204,206. The activation of the container cartridges 204,206 is sequential, the container cartridge 204 being activated prior to the activation of the container cartridge 206.

By using the single discharge outlet 208 as the mechanisms to release the fluid from both containers 102,104, the fire metering assembly 200 saves space, weight, and cost by reducing the number of necessary components that makeup the fire metering assembly 200. The second fluid container 104 may act as a back-up to the first fluid container 102 should the first fluid container 102 be prematurely released or otherwise damaged.

The fire metering assembly 200 may have one or more fasteners or mounts 218. The one or more fasteners or mounts 218 may be positioned in the rear of each of the fluid containers 102,104 as shown in FIG. 3A so that the fire metering assembly 200 may be fastened or mounted to a wall or a surface of the cargo hold of the aircraft. In some embodiments, only some fluid containers may have one or more fasteners or mounts 218. The fire metering assembly 200 may have one or more temperature compensated pressure switches 220. The temperature compensated pressure switch 220 may be inserted or positioned within the payload area 106 of the first fluid container 102 on one end to measure the pressure within the payload area 106 and may indicate whether there is a pressure drop within the payload area 106, which may indicate that there is a leak or that the fluid has been discharged. In some embodiments, the temperature compensated pressure switch 220 may be additionally or alternatively be inserted or positioned within the payload area 108 as shown in FIG. 3A. Additionally, the one or more fluid containers 102,104 may each have a fill fitting 222 to fill the one or more fluid containers 102,104 with the fluid.

FIG. 3B shows a fire metering assembly 200, which has a third fluid container 212, which is in fluid communication with the second fluid container 104 via another discharge tube 202 when the sealing discs 210d-e within the discharge tube 202 are ruptured, punctured, or otherwise opened. The third fluid container 212 may act as another back-up to the first and second fluid containers 102,104. The fire metering assembly 200 may have one or more additional container cartridges 214. The one or more additional container cartridges 214 are similar to the container cartridges 204,206, as described above. When the additional container cartridge 214 is actuated or activated, the container cartridge 214 may rupture the sealing discs 210d-e within the discharge tube 202, which allows fluid from the payload area 216 of the third fluid container 212 to flow into the second fluid container 104. The other sealing discs 210a-c may have been previously ruptured or unsealed to allow for the fluid to flow through the other fluid containers and out the discharge outlet 208.

The fire metering assembly 200 may have one or more fasteners or mounts 218. The one or more fasteners or mounts 218 may be positioned in the rear of each of the fluid containers 102,104,212 as shown in FIG. 3B so that the fire metering assembly 200 may be fastened or mounted to a wall or a surface of the cargo hold of the aircraft. In some embodiments, only some fluid containers may have one or more fasteners or mounts 218. The fire metering assembly 200 may have one or more temperature compensated pressure switches 220. The temperature compensated pressure switch 220 may be inserted or positioned within the payload area 106 of the first fluid container 102 on one end to measure the pressure within the payload area 106 and may indicate whether there is a pressure drop within the payload area 106, which may indicate that there is a leak or that the fluid has been discharged. In some embodiments, the temperature compensated pressure switch 220 may be additionally or alternatively be inserted or positioned within the payload areas 108,216 as shown in FIG. 3B. Additionally, the one or more fluid containers 102,104,212 may each have a fill fitting 222 to fill the one or more fluid containers 102,104,212 with the fluid.

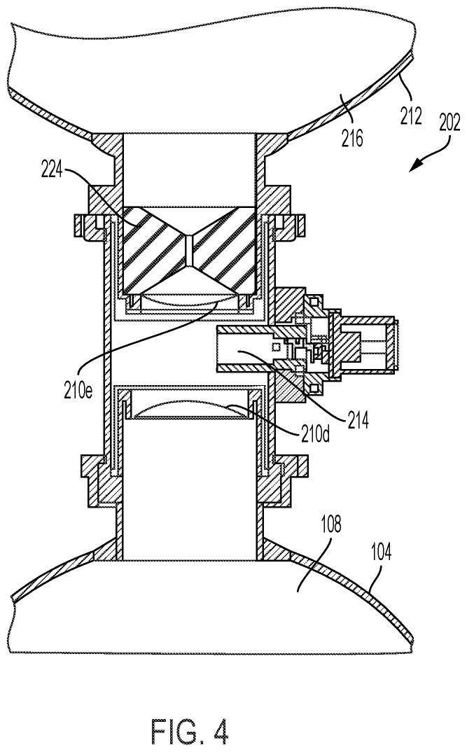

FIG. 4 shows a sectional view of a discharge tube 202 of the multi-shot fire metering assembly 200 shown in FIG. 3B. The sealing discs 210d-e within the discharge tube 202 may be ruptured, punctured, or otherwise opened by the container cartridge 214. The blast radius of the container cartridge 214 may allow the sealing discs 210d-e to both be opened. The opening of the sealing discs 210d-e may be simultaneous. Once the sealing discs 210d-e are opened, fluid from the payload area 216 of the third fluid container 212 may flow into the second fluid container 104. The discharge tube 202 may include a metering orifice 224. The metering orifice 224 may be positioned proximal to the third fluid container 212 and distal to the second fluid container 104. The metering orifice 224 may be configured to control release or flow rate of the fluid from the third payload area 216. As such, the flow of the fluid from the third payload area 216 into the second payload area 108 may be slower than the flow of the fluid from the second payload area 108 into the first payload area 106 and the flow of the fluid from the first payload area 106 when exiting out of the fire metering assembly 200.

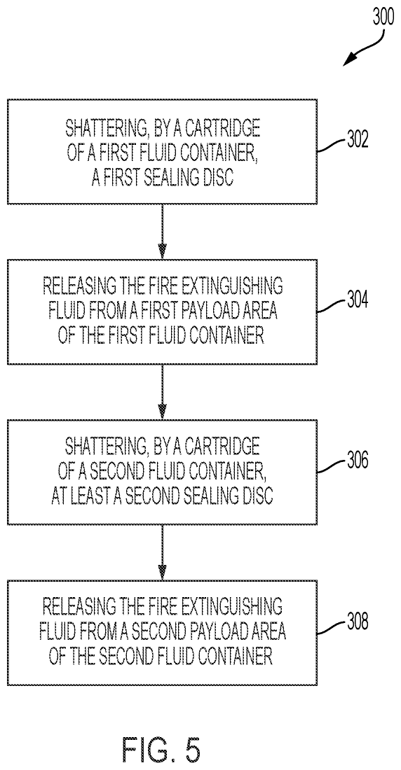

FIG. 5 shows a flow diagram of an example process 300 for releasing fire extinguishing fluid from a multi-shot fire metering assembly. The process 300 may utilize the fire metering assembly 100 shown in FIGS. 1-2 or the fire metering assembly 200 shown in FIGS. 3A-3B. The process 300 may begin with block 302.

In block 302, the process 300 may include shattering a first sealing disc by a first fluid container cartridge. The first sealing disc may be the sealing disc 105 shown in FIG. 1 or the sealing disc 210c shown in FIGS. 3A-3B. The first fluid container cartridge may be the container cartridge 114 shown in FIG. 1 or the container cartridge 204 shown in FIGS. 3A-3B. The container cartridges 114,204 may be actuation devices, which may be mechanically or electrically activated, such as an explosive pyrotechnic device or cartridge. The actuation device may be electrically activated to detonate and shatter, destroy, or otherwise tear apart or puncture the sealing discs 105,210c, such as a hermetically sealed rupturable disc, to allow the fluid, which may be pressurized, to escape the payload area 106 (see FIGS. 1, 3A-3B).

In block 304, the process 300 may include releasing the fluid from the payload area 106 of the first fluid container 102. (see FIGS. 1, 3A-3B). The release of the fluid may be directed by discharge outlets 110,208 (see FIGS. 1, 3A-3B).

In block 306, the process 300 may include shattering at least one second sealing disc by a second fluid container cartridge. The at least one second sealing disc may be the sealing disc 105 shown in FIG. 1 or the sealing discs 210a-b shown in FIGS. 3A-3B. The second fluid container cartridge may be the container cartridge 116 shown in FIG. 1 or the container cartridge 206 shown in FIGS. 3A-3B. The container cartridges 114,204 may be actuation devices, which may be mechanically or electrically activated, such as an explosive pyrotechnic device or cartridge. The actuation device may be electrically activated to detonate and shatter, destroy, or otherwise tear apart or puncture the sealing discs 105,210a-b, such as a hermetically sealed rupturable disc, to allow the fluid, which may be pressurized, to escape the payload area 108 (see FIGS. 1, 3A-3B).

The process 300 may conclude with block 308. In block 308, the process 300 may include releasing the fluid from the payload area 108 of the second fluid container 104. (see FIGS. 1, 3A-3B). The release of the fluid may be directed by discharge outlets 112,208 (see FIGS. 1, 3A-3B). In the fire metering assembly 200, the discharge tube 202 (see FIGS. 3A-3B) may act as a conduit or passageway for the fluid to flow from the second fluid container 104 to flow into the first fluid container 102 (see FIGS. 3A-3B) and out through the discharge outlet 208. For the fire metering assembly 100, the release of the fluid from the first payload area 106 and the release of the fluid from the second payload area 108 may be controlled independently. As such, the release of the fluid from the first payload area 106 and the release of the fluid from the second payload area 108 may be simultaneous or sequential as desired by a user (e.g., a pilot) of the fire metering assembly 100. For the fire metering assembly 200, the fluid from the second payload area 108 may only be released into the first payload area 106 after the fluid from the first payload area 106 is released.

In some embodiments, such as the fire metering assembly 200 shown in FIG. 3B, the process 300 may include shattering the sealing discs 210d-e by the additional container cartridge 214, and releasing the fluid from the third payload area 216 of the third fluid container 212 into the second payload are 108 of the second fluid container 104 through the discharge tube 202 after the fluid from the second payload area 108 is released.

Exemplary embodiments of the invention have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A multi-shot fire metering assembly, comprising:
a first fluid container having a first payload area for storing a fire extinguishing fluid;
a second fluid container positioned within the first payload area and having a second payload area for storing the fire extinguishing fluid; and
a first discharge outlet for directing the fire extinguishing fluid when released.

2. The multi-shot fire metering assembly of claim 1, further comprising a second discharge outlet in fluid communication with the second fluid container and configured to direct the fire extinguishing fluid when released, wherein the first discharge outlet is in fluid communication with the first fluid container.

3. The multi-shot fire metering assembly of claim 2, further comprising a first container cartridge configured to be electrically activated to shatter a first sealing disc to release the fire extinguishing fluid in the first payload area through the first discharge outlet, wherein the first container cartridge is a pyrotechnic device.

4. The multi-shot fire metering assembly of claim 3, further comprising a second container cartridge configured to be electrically activated to shatter a second sealing disc to release the fire extinguishing fluid in the second payload area through the second discharge outlet, wherein the second container cartridge is a pyrotechnic device.

5. The multi-shot fire metering assembly of claim 4, further comprising a computing device configured to activate the first container cartridge and the second container cartridge.

6. The multi-shot fire metering assembly of claim 1, further comprising one or more fasteners or mounts coupled to an outer surface of the first fluid container and configured to mount or couple the first fluid container onto a wall or a surface of an aircraft.

7. The multi-shot fire metering assembly of claim 1, further comprising a temperature compensated pressure switch configured to compensate for pressure change due to temperature in at least one of the first fluid container or the second fluid container.

8. A multi-shot fire metering assembly, comprising:
a first fluid container having a first payload area for storing a fire extinguishing fluid;
a second fluid container having a second payload area for storing the fire extinguishing fluid;
a discharge tube positioned in between the first fluid container and the second fluid container, the discharge tube having a first sealing disc and a second sealing disc; and
a discharge outlet having a third sealing disc and configured to direct the fire extinguishing fluid when released.

9. The multi-shot fire metering assembly of claim 8, wherein the second fluid container is in fluid communication with the first fluid container via the discharge tube when the second sealing disc is pierced or punctured.

10. The multi-shot fire metering assembly of claim 9, further comprising a first container cartridge configured to be electrically activated to shatter the third sealing disc to release the fire extinguishing fluid in the first payload area through the discharge outlet, wherein the first container cartridge is a pyrotechnic device.

11. The multi-shot fire metering assembly of claim 10, further comprising a second container cartridge configured to be electrically activated to shatter the first sealing disc and the second sealing disc to release the fire extinguishing fluid in the second payload area through the discharge outlet via the first fluid container.

12. The multi-shot fire metering assembly of claim 11, further comprising a computing device configured to activate the first container cartridge and the second container cartridge.

13. The multi-shot fire metering assembly of claim 10, further comprising a third fluid container having a third payload area for storing the fire extinguishing fluid and a second discharge tube positioned in between the second fluid container and the first fluid container and having a fourth sealing disc and a fifth sealing disc.

14. The multi-shot fire metering assembly of claim 13, further comprising a metering orifice positioned in between the second fluid container and the third fluid container configured to control release of the fire extinguishing fluid in the third payload area.

15. The multi-shot fire metering assembly of claim 10, further comprising one or more fasteners or mounts coupled to an outer surface of the first fluid container and an outer surface of the second fluid container, and configured to mount or couple the first fluid container and the second fluid container onto a wall or a surface of an aircraft.

16. A method for releasing fire extinguishing fluid from a multi-shot fire metering assembly, comprising:
shattering, by a cartridge of a first fluid container, a first sealing disc;
releasing the fire extinguishing fluid from a first payload area of the first fluid container;
shattering, by a cartridge of a second fluid container, at least a second sealing disc; and
releasing the fire extinguishing fluid from a second payload area of the second fluid container.

17. The method of claim 16, wherein the second fluid container is positioned within the first payload area and releasing the fire extinguishing fluid from the first payload area and the second payload area are controlled independently of each other.

18. The method of claim 16, wherein the fire extinguishing fluid from the second payload area is released into the first payload area after the fire extinguishing fluid from the first payload area is released and at least the second sealing disc includes a third sealing disc.

19. The method of claim 18, further comprising shattering, by a cartridge of a third fluid container, a fourth sealing disc and a fifth sealing disc, and releasing the fire extinguishing fluid from a third payload area of the third fluid container into the second payload area after the fire extinguishing fluid from the second payload area is released.

20. The method of claim 19, wherein the fire extinguishing fluid from the third payload area is released through a metering orifice positioned in between the second fluid container and the third fluid container to control the release.
